(19) United States
(12) Patent Application Publication
(10) Pub. No.: US 2019/0251924 A1
(43) Pub. Date: Aug. 15, 2019

(54) DISPLAY PANEL, DISPLAY APPARATUS AND VOLTAGE COMPENSATION METHOD THEREOF

(71) Applicants: HKC Corporation Limited, Shenzhen (CN); Chongqing HKC Optoelectronics Technology Co., Ltd., Chongqing (CN)

(72) Inventor: WEI FU, Chongqing (CN)

(21) Appl. No.: 16/329,230

(22) PCT Filed: May 10, 2017
(86) PCT No.: PCT/CN2017/083774

§ 371 Date: Feb. 28, 2019

(30) Foreign Application Priority Data
Nov. 21, 2016 (CN) 201611040678.8

(51) Int. Cl. G09G 3/36; G02F 1/1362; G02F 1/133

(52) U.S. Cl. CPC G09G 3/3696; G09G 2330/021; G02F 1/13306; G02F 1/136286

(57) ABSTRACT

The present application discloses a display panel, a display apparatus and a voltage compensation method thereof. The display panel includes an array substrate, a reference voltage generator and a compensation voltage generator, the signal lines and at least one compensation line are disposed on the array substrate, the signal line includes a first disconnected line and a second disconnected line; the reference voltage generator transmitting a reference voltage signal, and a first end of the first disconnected line is connected to the reference voltage generator to transmit the reference voltage signal; the compensation voltage generator transmitting a compensation voltage signal, and a second end of the compensation line is connected to the compensation voltage generator to transmit the compensation voltage signal to the second disconnected line, and a level of the compensation voltage signal is greater than a level of the reference voltage signal.

### TECHNICAL FIELD

The present application relates to the technical field of displays, and particularly relates to a display panel, a display apparatus and a voltage compensation method thereof.

### BACKGROUND

Liquid crystal display apparatuses have numerous advantages, such as a thin body, power savings, no radiation, etc., and are widely used. Most liquid crystal display apparatuses are backlight liquid crystal display apparatuses, each including a liquid crystal panel and a backlight module. Working principle of the liquid crystal panel is that liquid crystals are put in two parallel glass substrates, and a driving voltage is applied to the two glass substrates to control rotational direction of the liquid crystals, to refract light rays of the backlight module to generate a picture.

Thin film transistor liquid crystal display apparatuses (TFT-LCD apparatuses) currently maintain a leading status in the display field because of low power consumption, excellent picture quality, high production yield, and other properties. Similarly, the TFT-LCD apparatus includes a liquid crystal panel and a backlight module. The liquid crystal panel includes a color filter substrate (CF substrate) and a thin film transistor substrate (TFT substrate), and transparent electrodes on respective inner sides of the above substrates. A layer of liquid crystals (LCs) is positioned between two substrates. The liquid crystal panel changes a polarized state of light by controlling direction of the LCs through an electric field, and realizes penetration and obstruction of a light path via a polarized plate, so as to realize the purpose of display.

In manufacturing process of the TFT, environmental variation factors often cause line disconnection, causing signal transmission distortion and waveform distortion, so that the TFT charging time is made to be insufficient, causing dark lines to occur in the picture.

### SUMMARY

A technical problem to be solved by the present application is to provide a display panel which can prevent dark lines from occurring in the picture.

Furthermore, the present application further provides a display apparatus which is made of the display panel.

Furthermore, the present application further provides a voltage compensation method of a display panel to prevent dark lines from occurring in the picture.

The aim of the present application is achieved through the following methods.

The application discloses a display panel, the display panel includes: an array substrate including signal lines and at least one compensation line disposed on the array substrate, where the signal lines include a first disconnected line and a second disconnected line, and a first end of the second disconnected line is connected to a first end of the compensation line; a reference voltage generator generates a reference voltage signal, where a first end of the first disconnected line is connected to the reference voltage generator to transmit the reference voltage signal, and an disconnection was formed between a second end of the first disconnected line and a second end of the second disconnected line; and a compensation voltage generator generates a compensation voltage signal, where the second end of the compensation line is connected to the compensation voltage generator to transmit the compensation voltage signal to the second disconnected line; where a level of the compensation voltage signal is greater than a level of the reference voltage signal.

Optionally within a single period of driving time T of the signal line, a level of the compensation voltage signal is greater than level of the reference voltage signal within a first period of time T1, and a level of the compensation voltage signal is equal to the level of the reference voltage signal within a second period of time T2, where T=T1+T2. If the signal line is not disconnected, the complete signal line is driven within the single driving time T, so that the picture can be normally displayed. However, because of line disconnection, the compensation line is required to be wound to the disconnected line position through the edge of the array substrate and connected to the second disconnected line so as to be driven. The compensation voltage signal in the present application is transmitted to the second disconnected line at the disconnected line position through the compensation line, to drive the second disconnected line. The level of the compensation voltage signal is greater than the level of the reference voltage signal normally driving the signal line within the first time T1, so that the voltage charging time can be reduced, to neutralize over high parasitic resistances and/or parasitic capacitances generated because of the overlong compensation line, so as to prevent waveform transmission distortion and prevent dark lines. To prevent bright lines occurring because the compensation voltage is high for a long time from being formed, the compensation voltage signal is decreased within the second time T2 in the present application to make the compensation voltage signal identical to the reference voltage signal, or in other words, the compensation voltage signal is decreased if the normal charging of the second disconnected line is completed, specifically, the compensation voltage signal is identical to the reference voltage signal, so as to smoothly drive the second disconnected line, and avoid bright lines, thereby guaranteeing that the picture can be normally displayed.

Optionally within the single period of driving time T of the signal line, the compensation voltage signal is constant. This is another manner of controlling the compensation voltage to drive the second disconnected line of the present application. In this manner, a level of the compensation voltage signal may be slightly higher than a level of the reference voltage signal and slightly lower than the level of the compensation voltage signal within the first time T1 in the above-mentioned manner. In this way, within the single driving time T, the compensation voltage signal is always constant. Specifically, when the compensation voltage signal arrives at the second disconnected line through the compensation line, the charging time is also reduced as compared with driving by the reference voltage signal, and the brightness or gray scale of the second disconnected line is improved, which will not generate obvious dark lines.

Optionally the display panel further includes a first detector, and the first detector detects a picture of the display panel; and the compensation voltage generator configured to adjust a level of the compensation voltage signal according to different pictures of the display panels. The first detector detects the picture of the display panel, and the compensation voltage generator acquires information about the detected picture and adjusts the size of the compensation voltage signal according to a picture signal. For example, if the picture information acquired by the compensation voltage generator is that dark lines still occur in the picture at the disconnected line position, the compensation voltage generator increases the compensation voltage signal to drive the compensation line and the second disconnected line, and if the picture information acquired by the compensation voltage generator is that bright lines occur in the picture at the disconnected line position, the compensation voltage generator decreases the compensation voltage signal to drive the compensation line and the second disconnected line.

Optionally the compensation voltage generator is configured to select a level of the compensation voltage according to different pictures of the display panels, and superimpose the level of the compensation voltage with a level of the reference voltage signal to form the compensation voltage signal. Compensation voltage values may be divided into a plurality of different classes, for example, compensation voltage values may be divided into N different classes, N being a natural number greater than or equal to 2. The compensation voltage generator acquires information about the detected picture, and selects a compensation voltage value in accordance with different classes according to the picture signal and superimposes same with the reference voltage signal to form a better compensation voltage signal.

Optionally the display panel further includes a second detector, where the second detector detects a parasitic resistances and/or parasitic capacitances of the compensation line; and the compensation voltage generator is configured to adjust the level of the compensation voltage signal according to the parasitic resistances and/or parasitic capacitances. Signal lines are uniformly distributed on the array substrate, and disconnected lines are unstably generated. Therefore, the length of the compensation line varies due to the generation of different disconnected lines, the longer the compensation line is, the higher the parasitic resistances and parasitic capacitances thereof are, so that the compensation voltage generator can increase the compensation voltage signal according to the increase of the parasitic resistances and/or parasitic capacitances. Further, the compensation voltage generator can also increase same at equal interval according to the increase of the parasitic resistances and/or parasitic capacitances. In this way, different classes are formed, and the compensation line and the second disconnected line are driven through the different classes, so that the effect of repairing disconnected lines is better.

Optionally the display panel further includes a third detector, where the third detector detects the reference voltage signal; and the compensation voltage generator is configured to adjust the level of the compensation voltage signal according to the reference voltage signal. The reference voltage signal varies according to different gray scales of pictures, the higher the voltage is, the stronger the anti-damping capacity is, on the contrary, the weaker the anti-damping capacity is. Therefore, if the reference voltage signal is relatively high, the difference between the compensation voltage signal and the reference voltage signal is small, on the contrary, the difference is large. It can be seen that adjusting the compensation voltage signal according to the reference voltage signal can effectively avoid the problem of excessive compensation or insufficient compensation, thereby guaranteeing that the display effect of the first disconnected line is consistent with that of the second disconnected line

Optionally the compensation voltage generator is configured to select a level of the compensation voltage according to a preset rule, and superimpose the level of the compensation voltage with a level of the reference voltage signal to form the compensation voltage signal. Compensation voltage values may be divided into a plurality of different classes, for example, compensation voltage values may be divided into N different classes, N being a natural number greater than or equal to 2; the preset rule may be the picture information about the display panel, the parasitic resistance and/or parasitic capacitance of the compensation line or the reference voltage signal. The compensation voltage generator selects a compensation voltage value in accordance with different classes according to the above preset rule and superimposes same with the reference voltage signal to form a better compensation voltage signal.

According to another aspect of the present application, the application also discloses a display, including a display panel.

The application also discloses a voltage compensation method of a display panel, the display panel includes an array substrate, the array substrate includes signal lines, and the signal lines includes a first disconnected line and a second disconnected line, where a first end of the first disconnected line is connected to a reference voltage generator to transmit a reference voltage signal generated by the reference voltage generator, and an disconnection was formed between the second end of the first disconnected line and the second end of the second disconnected line; where a first end of the second disconnected line is connected to a first end of the compensation line disposed on the array substrate, and the second end of the compensation line is connected to the compensation voltage generator to transmit the compensation voltage signal generated by the compensation voltage generator to the second signal line; and the voltage compensation method includes steps:
detecting a picture of the display panel;
adjusting a level of the compensation voltage signal according to different pictures of the display panels by the compensation voltage generator; and
within a single period of driving time T of the signal line, a level of the compensation voltage signal to be greater than the reference voltage signal within a first period of time T1, and a level of the compensation voltage signal is equal to the level of the reference voltage signal within a second period of time T2, where T=T1+T2.

In the actual manufacturing process of the display panel, environmental variation factors often cause disconnection of the signal line, which causes signal transmission distortion and waveform distortion, so that the TFT charging time is made to be insufficient, causing dark lines to be formed at the other section of the disconnected lines of the signal line and then causing the picture display effect to be poor. Compared with the prior art, the present application has the technical effects.

In the present application, the reference voltage generator is still connected to the first disconnected line of the disconnected lines of the signal line, and the reference voltage signal transmitted by the reference voltage generator can normally drive the first disconnected line. In the present application, the compensation line is connected to a compensation voltage generator, a level of a compensation voltage signal transmitted by the compensation voltage generator is greater than a level of the reference voltage signal transmitted by the reference voltage generator, and the compensation voltage signal drives the compensation line and drives the second disconnected line connected to the compensation line. Compared with driving the compensation line and the second disconnected line by the reference voltage signal, the present application can greatly reduce the charging and discharging time, and then can prevent signal transmission distortion and prevent waveform distortion, so that the TFT charging time is made to be sufficient to guarantee that the display effect of the second disconnected line to be close to that of the first disconnected line, thereby avoiding dark lines and then making the picture to be normally displayed.

### BRIEF DESCRIPTION OF THE DRAWINGS

The drawings included are used for providing further understanding of embodiments of the present application, constitute part of the description, are used for illustrating implementation manners of the present application, and interpret principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a structural schematic diagram of a liquid crystal panel.

FIG. 2 is a waveform diagram of disconnected lines of a signal line.

FIG. 3 is a structural schematic diagram of a liquid crystal panel of an embodiment of the present application.

FIG. 4 is a waveform diagram of disconnected lines of a signal line of an embodiment of the present application.

FIG. 5 is a structural schematic diagram of a liquid crystal panel of an embodiment of the present application.

FIG. 6 is a structural schematic diagram of a liquid crystal panel of an embodiment of the present application.

FIG. 7 is a structural schematic diagram of a liquid crystal panel of an embodiment of the present application.

FIG. 8 is a structural schematic diagram of a liquid crystal panel of an embodiment of the present application.

FIG. 9 is a schematic diagram of a liquid crystal display apparatus of an embodiment of the present application.

FIG. 10 is a flowchart of a voltage compensation method of a liquid crystal panel of an embodiment of the present application.

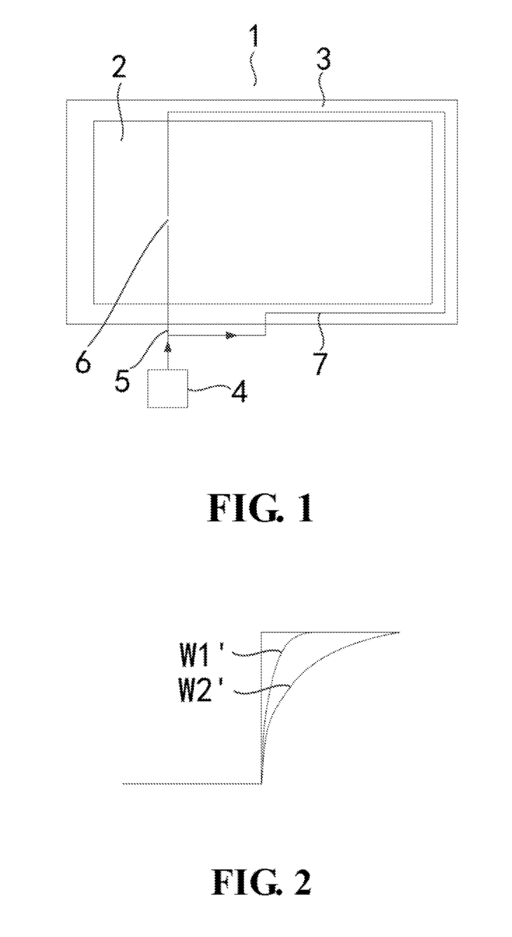

Legends: FIG. 1-FIG. 2: 1. liquid crystal panel; 2. array substrate: 3. glass substrate; 4. signal generator: 5. signal line; 6. disconnected line position; 7. compensation line;

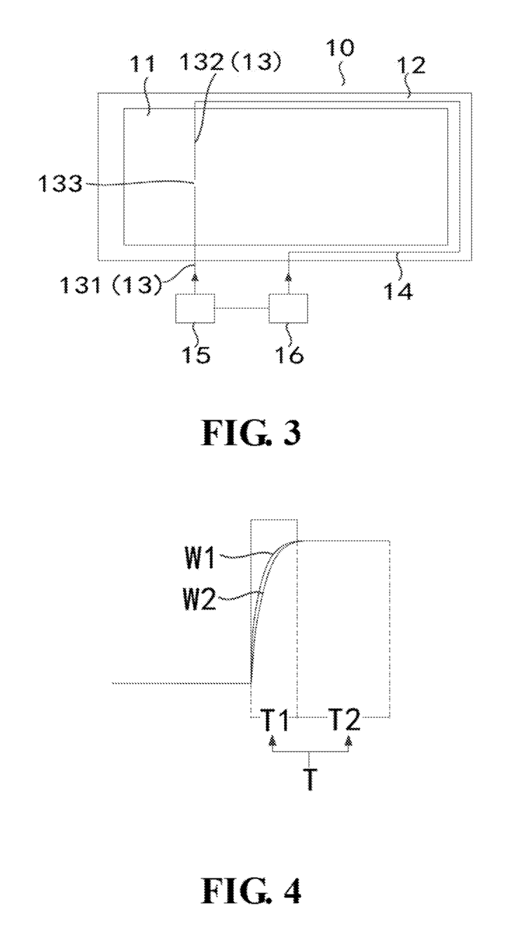

Legends: FIG. 3-FIG. 10: 10. liquid crystal panel; 11. array substrate: 12. substrate; 13. signal line; 131. first disconnected line; 132. second disconnected line; 133. disconnected line position; 14. compensation line; 15. reference voltage generator; 16. compensation voltage generator; 17. first detector; 18. second detector; 19. third detector: 100. liquid crystal display apparatus.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited “first” and “second” can explicitly or impliedly includes one or more features. In the description of the present application, the meaning of “a plurality of” is two or more unless otherwise specified. In addition, the term “includes” and any variant are intended to cover non-exclusive inclusion.

It should be noted in the description of the present application that, unless otherwise specifically regulated and defined, terms such as “installation,” “bonded,” and “bonding” shall be understood in broad sense, and for example, may refer to fixed bonding or detachable bonding or integral bonding; may refer to mechanical bonding or electrical bonding; and may refer to direct bonding or indirect bonding through an intermediate medium or inner communication of two elements. For those of ordinary skill in the art, the meanings of the above terms in the present application may be understood according to specific conditions.

The terms used herein are intended to merely describe specific embodiments, not to limit the exemplary embodiments. Unless otherwise noted clearly in the context, singular forms “one” and “single” used herein are also intended to include plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

In the actual manufacturing process of the display panel, environmental variation factors often cause disconnection of the signal line, which causes signal transmission distortion and waveform distortion, so that the TFT charging time is made to be insufficient, causing dark lines to be formed at the other section of the disconnected lines of the signal line and then causing the picture display effect to be poor. Therefore, the applicant already designs a technical solution of compensating the voltage at the disconnected line, see FIG. 1 and FIG. 2 for detail. As shown in FIG. 1, FIG. 1 is a schematic diagram of another display panel designed by the applicant, the display panel 1 includes an array substrate 2, where the array substrate 2 includes a glass substrate 3, a signal line 5 is disposed on the array substrate 2, and a signal transmitted by a signal generator 4 is transmitted through the signal line 5 if the signal line is disconnected. However, if the signal line 5 is disconnected, a compensation line 7 is required to be disposed around the edge of the glass substrate 3, and the compensation line 7 is connected to a disconnected line position 6 of the signal line 5 from the position of the signal generator 4, so that the signal can be transmitted. It can be known from FIG. 1 that the compensation line 7 is disposed around the edge of the glass substrate 3 and is required to be wound at a long distance, and since the signal line is wound around the edge of the glass substrate, the cable thereof is long, and the generated parasitic capacitance and resistance are high. Although the voltage at the disconnected line is compensated to a certain extent, since the parasitic capacitance and resistance of the compensation line are high, signal transmission distortion and waveform distortion are caused, so that the TFT charging time is made to be insufficient, causing dark lines to occur in the picture. More specifically, as shown in FIG. 2, FIG. 2 is a waveform diagram of two sections of signal line at both ends of the disconnected line position 6 driven by a reference voltage signal, where W1′ represents a waveform of one section of signal line directly connected to the reference voltage generator, and W2′ represents a waveform of the other section of signal line connected to the reference voltage generator through the compensation line. It can be known from FIG. 2 that the charging and discharging time of W2′ is much more than that of W1′, or in other words. W2′ has more significant waveform distortion as compared with W1′.

Therefore, the applicant further designs another technical solution of compensating the voltage at the disconnected line to prevent dark lines, specifically:

The display panel, the liquid crystal display apparatus and the voltage compensation method thereof of the present application are described below with reference to FIG. 3 to FIG. 10.

As shown in FIG. 3 to FIG. 10, the present application discloses a display panel, a liquid crystal display apparatus and a voltage compensation method thereof. The liquid crystal display apparatus 100 includes a display panel 10 and a backlight module, where the display panel 10 compensates the voltage at the second disconnected line through the voltage compensation method of the display panel, to prevent dark lines. Specifically, the display panel 10 includes:

an array substrate 11 including signal lines 13 and at least one compensation line 14 disposed on the army substrate 11, where the signal line 13 includes a first disconnected line 131 and a second disconnected line 132, and a first end of the second disconnected line 132 is connected to a first end of the compensation line 14;

a reference voltage generator 15 transmitting a reference voltage signal, where a first end of the first disconnected line 131 is connected to the reference voltage generator 15 to transmit the reference voltage signal, and an interval set between a second end of the first disconnected line 131 and a second end of the second disconnected line 132 forms a disconnected line, so as to further form a disconnected line position 133; and

a compensation voltage generator 16 transmitting a compensation voltage signal, where a second end of the compensation line 14 is connected to the compensation voltage generator 16 to transmit the compensation voltage signal to the second disconnected line 132; and

where a level of the compensation voltage signal is greater than a level of the reference voltage signal.

Specifically, the army substrate 11 includes a substrate 12. The substrate 12 in the present application is made of a glass substrate since the glass substrate has the advantages of good light transmittance, and ease of processing and manufacturing. The compensation line 14 is disposed at the edge of the substrate 12 and disposed to a second end of the disconnected line of the signal line around the edge of the substrate 12, thereby implementing the electrical connection between the compensation line 14 and the second disconnected line 132.

Compared with the technique of compensating the voltage at the disconnected line in FIG. 1, in the present application, the reference voltage generator 15 is still connected to the first disconnected line 131 of the disconnected lines of the signal line 130, and the reference voltage signal transmitted by the reference voltage generator 15 can normally drive first disconnected line 131. In the present application, the compensation line 14 is connected to a compensation voltage generator 16, a level of a compensation voltage signal transmitted by the compensation voltage generator 16 is greater than a level of the reference voltage signal transmitted by the reference voltage generator, and the compensation voltage signal drives the compensation line 14 and drives the second disconnected line 132 connected to the compensation line 14. Compared with driving the compensation line 14 and the second disconnected line 132 by the reference voltage signal, the present application can greatly reduce the charging and discharging time, and then can prevent signal transmission distortion and prevent waveform distortion, so that the TFT charging time is made to be sufficient to guarantee that the second disconnected line can be normally driven, thereby avoiding dark lines and making the picture to be normally displayed.

The present application will be further described in detail below in combination with the drawings and preferred embodiments.

In one or more embodiments, as shown in FIG. 3 and FIG. 4, where FIG. 3 is a structural schematic diagram of a display panel of an embodiment of the present application, and FIG. 4 is a waveform diagram of a first disconnected line and a second disconnected line of an embodiment of the present application. In the present embodiment, within a single driving time T of the signal line, a level of the compensation voltage signal is greater than a level of the reference voltage signal within a first time T1 (the reference signal voltage can be referred to the driving waveform on both ends of disconnected lines of a signal line, as shown in FIG. 1 and FIG. 2) and is equal to the level of the reference voltage signal within a second time T2, where T=T1÷T2. If the signal line is not disconnected, the complete signal line is driven within the single driving time T, so that the picture can be normally displayed. However, because of line disconnection, the compensation line 14 is required to be wound to the disconnected line position 133 through the edge of the glass substrate of the array substrate 11 and connected to the second disconnected line 132 so as to be driven. The compensation voltage signal in the present embodiment is transmitted to a second disconnected line 143 at a disconnected line position 144 through the compensation line 14, to drive the second disconnected line 143. A level of the compensation voltage signal is greater than a level of the reference voltage signal normally driving the signal line within the first time T1, so that the voltage charging time can be reduced, to neutralize over high parasitic resistance and/or parasitic capacitance generated because of overlong compensation line 14, so as to prevent waveform transmission distortion and prevent dark lines. To prevent bright lines occurring because the compensation voltage is high for a long time from being formed, the compensation voltage signal is decreased within the second time T2 in this embodiment to make the compensation voltage signal identical to the reference voltage signal, or in other words, the compensation voltage signal is decreased if the normal charging of the second disconnected line 132 is completed, specifically, the compensation voltage signal is identical to the reference voltage signal, so as to smoothly drive the second disconnected line 132, and avoid bright lines, thereby guaranteeing that the picture can be normally displayed.

Further as shown in FIG. 4, W1 represents a waveform of the first disconnected line 131 driven by the reference voltage generator through the reference voltage signal transmitted thereby. Since the first disconnected line 131 is directly connected to the reference voltage generator, and the reference voltage generator normally drives the first disconnected line 131, the first disconnected line 131 can be normally displayed, the waveform thereof may not be distorted, and dark lines may not be formed. W2 represents a waveform of the second disconnected line 132 driven by the compensation voltage generator through the compensation voltage signal transmitted thereby. Although over high parasitic resistances and/or parasitic capacitances are generated due to overlong compensation line 14, in the present embodiment, a level of the compensation voltage signal driving the compensation line 14 and the second disconnected line 132 within the first time T1 is greater than a level of the reference voltage signal, so that the charging and discharging time can be greatly reduced, to neutralize the parasitic resistance and/or parasitic capacitance possessed by the compensation line 14. Thus, the waveform W2 of the second disconnected line 132 is made to be substantially identical to the waveform W1 of the first disconnected line 131, or in other words, the area repaired by driving the compensation line and the second disconnected line by the compensation voltage signal is made to be substantially identical to the area repaired by driving the first disconnected line by the reference voltage signal. In this way, no obvious waveform distortion is caused, and dark lines are avoided, thereby guaranteeing that the picture is normally displayed. This is another preferred manner of configuring the compensation voltage generator of the present embodiment.

In one or more embodiments, the compensation voltage generator 16 is configured to select a level of the compensation voltage according to a preset rule and superimpose the level of the compensation voltage with the reference voltage signal to form the compensation voltage signal. Level of the compensation voltages may be divided into a plurality of different classes, for example, level of the compensation voltages may be divided into N different classes, N being a natural number greater than or equal to 2, and classes may be specifically divided at regular intervals, for example, divided at a gradual interval of 1. The preset rule may be the picture information about the display panel, the parasitic resistance and/or parasitic capacitance of the compensation line or the reference voltage signal. The compensation voltage generator selects a level of the compensation voltage in accordance with different classes according to the above preset rule and superimposes same with the reference voltage signal to form a better compensation voltage signal.

Specifically, the reference voltage generator 15 is electrically connected to the compensation voltage generator 16. The reference voltage generator transmits the reference voltage signal to the compensation voltage generator while driving the signal line within the single driving time T. The compensation voltage generator determines a specific level of the compensation voltage of a certain class through the preset rule, and then directly superimposes the level of the compensation voltage with the reference voltage signal, thereby forming the compensation voltage signal of the present embodiment. In this way, compensation voltage signals of different classes may be generated by level of the compensation voltages of different classes. In this way, a better compensation voltage signal can be selected to drive the compensation line and the second disconnected line, so that not only dark lines are prevented from being generated, but also bright lines generated due to over high compensation voltage signal are prevented from being formed, thereby further guaranteeing that the picture can be normally displayed.

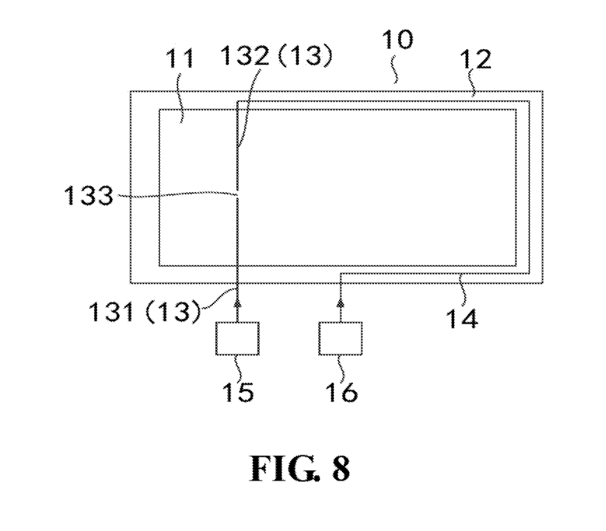

However, the compensation voltage generator may not be electrically connected to the reference voltage generator, that is to say, the two are separated, as shown in FIG. 8. In this way, the compensation voltage generator may be configured to transmit compensation voltage signals according to the above preset rule, that is, the compensation voltage generator may be directly configured to transmit a plurality of compensation voltage signals of different classes, and classes may be specifically divided at regular intervals, for example, divided at a gradual interval of 1. By directly configuring the compensation voltage generator to transmit compensation voltage signals of different classes, a better compensation voltage signal can also be selected to drive the compensation line and the second disconnected line, so that not only dark lines are prevented from being generated, but also bright lines generated due to over high compensation voltage signal are prevented from being formed, thereby further guaranteeing that the picture can be normally displayed.

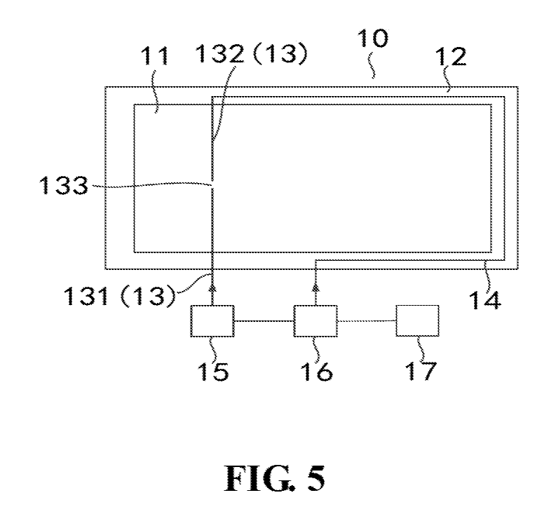

In one or more embodiments, level of the compensation voltages of different classes are selected through preset rules or compensation voltage signals of different classes are selected through preset rules. In the preset rule 1, as shown in FIG. 5, FIG. 5 is a structural schematic diagram of another display panel of an embodiment of the present application, the display panel 10 further includes a first detector 17, where the first detector 17 detects the picture of the display panel; and the compensation voltage generator 16 is configured to adjust the level of the compensation voltage signal according to different pictures of the display panels. The first detector 17 detects the picture of the display panel 10, and the compensation voltage generator 16 acquires information about the detected picture and adjusts the level of the compensation voltage signal according to a picture signal. For example, if the picture information acquired by the compensation voltage generator is that dark lines still occur in the picture at the disconnected line position, the compensation voltage generator increases the compensation voltage signal to drive the compensation line and the second disconnected line, and if the picture information acquired by the compensation voltage generator is that bright lines occur in the picture at the disconnected line position, the compensation voltage generator decreases the compensation voltage signal to drive the compensation line and the second disconnected line.

On the other hand, the compensation voltage generator is configured to select a level of the compensation voltage according to different pictures of the display panels and superimpose the level of the compensation voltage with the reference voltage signal to form the compensation voltage signal. The compensation voltage generator acquires the information about the detected picture, and selects a level of the compensation voltage in accordance with different classes according to the picture signal and superimposes same with the reference voltage signal to form a better compensation voltage signal.

The first detector may use a charge-coupled device (CCU) to sense the picture, make a response according to the sensed picture and transmit the response to the compensation voltage generator, so that the compensation voltage generator transmits the better compensation voltage signal.

Specifically, the first detector may acquire the brightness of the picture, specifically the brightness of the first disconnected line and the brightness of the second disconnected line, and compare the brightness of the first disconnected line with that of the second disconnected line, to determine whether dark lines, bright lines and the like are formed at the second disconnected line according to the brightness difference between the first disconnected line and the second disconnected line. For example, the first detector detects that the first disconnected line has 256 gray scales while the second disconnected line only has 150 gray scales. The brightness of the second disconnected line is obviously less than that of the first disconnected line, so that dark lines may be formed. After acquiring the detection result of the first detector, the compensation voltage generator may transmit high-class compensation voltage signals to improve the brightness of the second disconnected line, so that the gray scales of the second disconnected line are close to that of the first disconnected line. Alternatively, the compensation voltage generator transmits different high classes of compensation voltage signals to obtain gray scales closer to that of the first disconnected line through the continuous detection of the first detector, so that the brightness of the second disconnected line is closer to that of the first disconnected line, thereby making the picture display effect better.

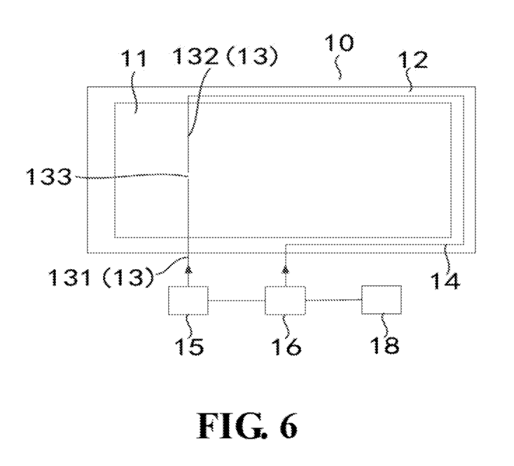

In one or more embodiments, level of the compensation voltages of different classes are selected through preset rules or compensation voltage signals of different classes are selected through preset rules. In the preset rule 2, as shown in FIG. 6, FIG. 6 is a structural schematic diagram of yet another display panel of an embodiment of the present application. The display panel 10 further includes a second detector 18, where the second detector 18 detects parasitic resistances and/or parasitic capacitances of the compensation line; and the compensation voltage generator is configured to adjust the level of the compensation voltage signal according to different parasitic resistances an/or parasitic capacitances. Signal lines are uniformly distributed on the array substrate, and disconnected lines are unstably generated. Therefore, the length of the compensation line varies due to the generation of different disconnected lines, the longer the compensation line is, the higher the parasitic resistances and parasitic capacitances thereof are, so that the compensation voltage generator can increase the compensation voltage signal according to the increase of the parasitic resistances and/or parasitic capacitances. Further, the compensation voltage generator can also increase same at equal interval according to the increase of the parasitic resistances and/or parasitic capacitances. In this way, different classes are formed, and the compensation line and the second disconnected line are driven through the different classes, so that the effect of repairing disconnected lines is better.

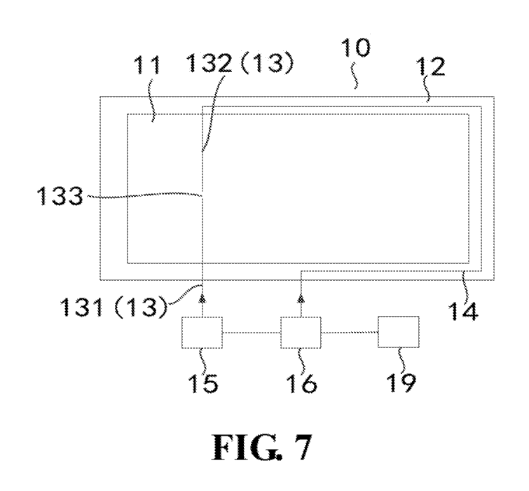

In one or more embodiments, level of the compensation voltages of different classes are selected through preset rules or compensation voltage signals of different classes are selected through preset rules. In the preset rule 3, as shown in FIG. 7, FIG. 7 is a structural schematic diagram of yet another display panel of an embodiment of the present application. The display panel 10 further includes a third detector 19, where the third detector 19 detects the reference voltage signal; and the compensation voltage generator is configured to adjust the level of the compensation voltage signal according to the reference voltage signal. The reference voltage signal varies according to different gray scales of pictures, the higher the voltage is, the stronger the anti-damping capacity is on the contrary, the weaker the anti-damping capacity is. Therefore, if the reference voltage signal is relatively high, the difference between the compensation voltage signal and the reference voltage signal is small, on the contrary, the difference is large. It can be seen that adjusting the compensation voltage signal according to the reference voltage signal can effectively avoid the circumstances of excessive compensation or insufficient compensation, thereby guaranteeing that the display effect of the first disconnected line is consistent with that of the second disconnected line.

Another embodiment also discloses a display panel, where the present embodiment is different from the above-mentioned embodiment in that: within the single driving time T of the signal line, the compensation voltage signal is constant. This is another manner of controlling the compensation voltage to drive the second disconnected line of the present application. In this manner, a level of the compensation voltage signal may be slightly higher than a level of the reference voltage signal and slightly lower than the level of the compensation voltage signal within the first time T1 in the above-mentioned embodiment. In this way, within the single driving time T, the compensation voltage signal in the present embodiment is always constant. Specifically, when the compensation voltage signal in the present embodiment arrives at the second disconnected line through the compensation line, the charging time is also reduced as compared with driving by the reference voltage signal, and the brightness or gray scale of the second disconnected line is improved, which will not generate obvious dark lines. Further, the second disconnected line driven by the compensation voltage signal in the embodiment of the present application may form a waveform, and the area repaired by the waveform formed in the present embodiment is substantially identical to the area repaired by W1. In this way, charging and discharging can be quickly completed. However, the waveform formed in the present embodiment may be higher than W1 and W2, so that slight bright lines may be formed. Compared with the above-mentioned embodiment, the present embodiment is convenient and easy to control and drive, but the picture display effect is slightly poor. However, compared with the technique of compensating the voltage at the disconnected line in FIG. 1, this embodiment can still mitigate dark lines and improve the picture.

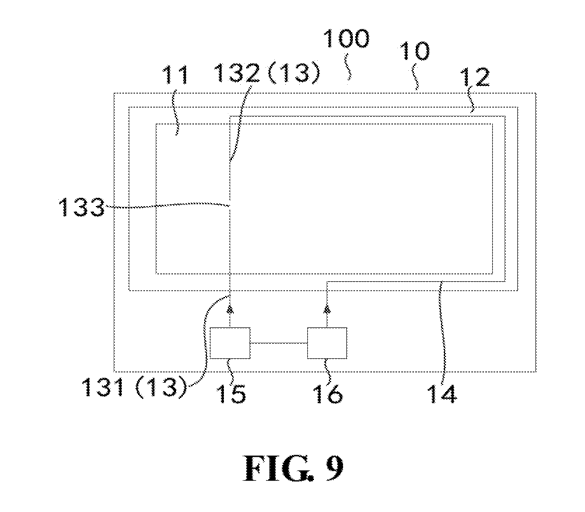

As shown in FIG. 9, FIG. 9 is a schematic diagram of a liquid crystal display apparatus of an embodiment of the present application. The liquid crystal display apparatus 100 of the present embodiment includes a display panel 10 and a backlight module, where FIG. 9 only shows one structure of the liquid crystal display apparatus of the present embodiment, see display panels in the above-mentioned embodiments for display panels in is embodiment in detail, which will not be repeated one by one herein.

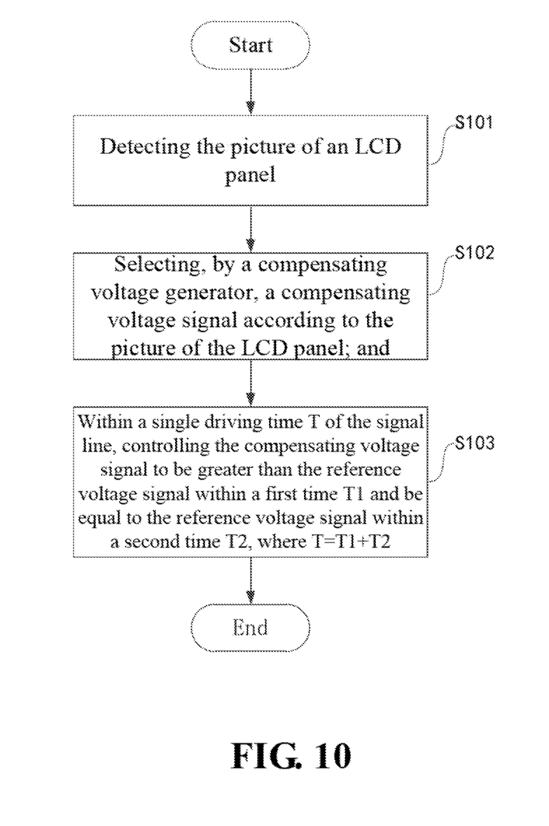

As shown in FIG. 10, FIG. 10 is a flowchart of a voltage compensation method of a display panel of an embodiment of the present application.

The voltage compensation method of the display panel of the present embodiment includes steps:

S101: detecting a picture of the display panel;

S102: selecting, by the compensation voltage generator, a compensation voltage signal according to different pictures of the display panels; and

S103: within a single driving time T of the signal line, controlling a level of the compensation voltage signal to be greater than a level of the reference voltage signal within a first time T1 and be equal to the level of the reference voltage signal within a second time T2, where T=T1+T2.

In S101: the first detector may use a charge-coupled device (CCD) to sense the picture to implement detection, make a response according to the sensed picture and transmit the response to the compensation voltage generator, so that the compensation voltage generator transmits a better compensation voltage signal.

Specifically, the first detector may acquire the brightness of the picture through the CCD, specifically, the brightness of the first disconnected line and the brightness of the second disconnected line, and compare the brightness of the first disconnected line with that of the second disconnected line, to determine whether dark lines, bright lines and the like are formed at the second disconnected line according to the brightness difference between the first disconnected line and the second disconnected line. For example, the first detector detects that the first disconnected line has 256 gray scales while the second disconnected line only has 150 gray scales. The brightness of the second disconnected line is obviously less than that of the first disconnected line, so that dark lines may be formed. After completing picture detection, the CCD transmits the detection result to the compensation voltage generator, so that the compensation voltage generator goes to the next step.

In S102, the compensation voltage generator directly adjusts the level of the compensation voltage signal according to different pictures of the display panels, specifically, the compensation voltage generator transmits a high-class compensation voltage signal as long as receiving the picture information to improve the brightness of the second disconnected line, so that the gray scales of the second disconnected line are close to that of the first disconnected line. Alternatively, the compensation voltage generator transmits different high classes of compensation voltage signals to obtain gray scales closer to that of the first disconnected line through the continuous detection of the first detector, so that the brightness of the second disconnected line is closer to that of the first disconnected line, thereby making the picture display effect better. Of course, if it is detected that the brightness of the second disconnected line in the picture is greater than that of the first disconnected line, the compensation voltage generator transmits a low-class compensation voltage signal to make adjustment, so as to select a better compensation voltage signal.

Meanwhile, the compensation voltage generator also selects a level of the compensation voltage according to different pictures of the display panels and superimposes the level of the compensation voltage with the reference voltage signal to form the compensation voltage signal. The compensation voltage generator acquires the information about the detected picture, selects a level of the compensation voltage in accordance with different classes according to the picture signal and superimposes same with the reference voltage signal to form a better compensation voltage signal. For example, level of the compensation voltages may be divided into N different classes, N being a natural number greater than or equal to 2, and classes may be specifically divided at regular intervals, for example, divided at a gradual interval of 1. The preset rule may be the picture information about the display panel, the parasitic resistance and/or parasitic capacitance of the compensation line or the reference voltage signal. The compensation voltage generator selects a level of the compensation voltage in accordance with different classes according to the above preset mile and superimposes same with the reference voltage signal to form a better compensation voltage signal.

Specifically, the reference voltage generator is electrically connected to the compensation voltage generator. The reference voltage generator transmits the reference voltage signal to the compensation voltage generator while driving the signal line within the single driving time T. The compensation voltage generator determines a specific level of the compensation voltage of a certain class through the picture information about the display panel and then directly superimposes the level of the compensation voltage with the reference voltage signal, thereby forming the compensation voltage signal of the present embodiment. In this way, compensation voltage signals of different classes may be generated by level of the compensation voltages of different classes. In this way, a better compensation voltage signal can be selected to drive the compensation line and the second disconnected line, so that not only dark lines are prevented from being generated, but also bright lines generated due to too high compensation voltage signal are prevented from being formed, thereby further guaranteeing that the picture can be normally displayed.

In S103, within the single driving time T of the signal line, a level of the compensation voltage signal is controlled to be greater than a level of the reference voltage signal within a first time T1 and be equal to the level of the reference voltage signal within a second time T2, where T=T1+T2.

Within the single driving time T of the signal line, a level of the compensation voltage signal is greater than a level of the reference voltage signal within a first time T1 (the reference voltage signal and the reference voltage can be referred to the driving waveform on both ends of disconnected lines of a signal line, as shown in FIG. 1, FIG. 2, FIG. 3 and FIG. 4; and is equal to the level of the reference voltage signal within a second time T2, where T=T1+T2. If the signal line is not disconnected, the complete signal line is driven within the single driving time T, so that the picture can be normally displayed. However, because of line disconnection, the compensation line is required to be wound to the disconnected line position through the edge of the glass substrate of the array substrate and connected to the second disconnected line so as to be driven. The compensation voltage signal in the present embodiment is transmitted to the second disconnected line at the disconnected line position through the compensation line, to drive the second disconnected line. A level of the compensation voltage signal is greater than a level of the reference voltage signal normally driving the signal line within the first time T1, so that the voltage charging time can be reduced, to neutralize over high parasitic resistance and/or parasitic capacitance generated because of overlong compensation line, so as to prevent waveform transmission distortion and prevent dark lines. To prevent bright lines occurring because the compensation voltage is high for a long time from being formed, the level of the compensation voltage signal is decreased within the second time T2 in this embodiment to make the compensation voltage signal identical to the reference voltage signal, or in other words, the compensation voltage signal is decreased if normal charging of the second disconnected line is completed, specifically, the compensation voltage signal is identical to the reference voltage signal, so as to smoothly drive the second disconnected line, and avoid bright lines, thereby guaranteeing that the picture can be normally displayed.

In combination FIG. 4, W1 represents a waveform of the first disconnected line driven by the reference voltage generator through the reference voltage signal transmitted thereby. Since the first disconnected line is directly connected to the reference voltage generator, and the reference voltage generator normally drives the first disconnected line, the first disconnected line can be normally displayed, the waveform thereof may not be distorted, and dark lines may not be formed. W2 represents a waveform of the second disconnected line driven by the compensation voltage generator through the compensation voltage signal transmitted thereby. Although over high parasitic resistances and/or parasitic capacitances are generated due to overlong compensation line, in the present embodiment, a level of the compensation voltage signal driving the compensation line and the second disconnected line within the first time T1 is greater than a level of the reference voltage signal, so that the charging and discharging time can be greatly reduced, to neutralize the parasitic resistances and/or parasitic capacitances possessed by the compensation line. Thus, the waveform W2 of the second disconnected line is made to be substantially identical to the waveform W1 of the first disconnected line, or in other words, the area repaired by driving the compensation line and the second disconnected line by the compensation voltage signal is made to be substantially identical to the area repaired by driving the first disconnected line by the reference voltage signal. In this way, no obvious waveform distortion is caused, and dark lines are avoided, thereby guaranteeing that the picture is normally displayed.

In one or more embodiments, in Step S101, other parameters of the display panel can also be detected in the present embodiment to adjust the compensation voltage signal transmitted by the compensation voltage generator.

Example 1, the parasitic resistances and/or parasitic capacitances of the compensation line are detected. The compensation voltage generator adjusts the level of the compensation voltage signal according to different parasitic resistances and/or parasitic capacitances. Signal lines are uniformly distributed on the array substrate, and disconnected lines unstably generated. Therefore, the length of the compensation line varies due to the generation of different disconnected lines, the longer the compensation line is, the higher the parasitic resistances and parasitic capacitances thereof are, so that the compensation voltage generator can increase the compensation voltage signal according to the increase of the parasitic resistances and/or parasitic capacitances. Further, the compensation voltage generator can also increase same at equal interval according to the increase of the parasitic resistances and/or parasitic capacitances. In this way, different classes are formed and the compensation line and the second disconnected line are driven through different classes, so that the effect of repairing disconnected lines is better.

Example 2, the reference voltage signal is detected. The compensation voltage generator adjusts the level of the compensation voltage signal according to the reference voltage signal. The reference voltage signal varies according to different gray scales of pictures, the higher the voltage is, the stronger the anti-damping capacity is on the contrary, the weaker the anti-damping capacity is. Therefore, if the reference voltage signal is relatively high, the difference between the compensation voltage signal and the reference voltage signal is smaller, on the contrary, the difference is large. It can be seen that adjusting the compensation voltage signal according to the reference voltage signal can effectively avoid the circumstances of excessive compensation or insufficient compensation, thereby guaranteeing that the display effect of the first disconnected line is consistent with that of the second disconnected line.

The above contents are further detailed descriptions of the present application in combination with specific optional embodiments. However, the specific implementation of the present application shall not be considered to be only limited to these descriptions. For those of ordinary skill in the art to which the present application belongs, several simple deductions or replacements may be made without departing from the conception of the present application, all of which shall be considered to belong to the protection scope of the present application.

What is claimed is:

1. A display panel, comprising:
an array substrate comprises signal lines and at least one compensation line disposed on the array substrate, wherein the signal lines comprise a first disconnected line and a second disconnected line, and a first end of the second disconnected line is connected to a first end of the compensation line;
a reference voltage generator generates a reference voltage signal, wherein a first end of the first disconnected line is connected to the reference voltage generator to transmit the reference voltage signal, and a disconnection was formed between a second end of the first disconnected line and a second end of the second disconnected line; and
a compensation voltage generator generates a compensation voltage signal, wherein the second end of the compensation line is connected to the compensation voltage generator to transmit the compensation voltage signal to the second disconnected line;
wherein a level of the compensation voltage signal is greater than a level of the reference voltage signal.

2. The display panel according to claim 1, wherein within a single period of driving time T of the signal line, a level of the compensation voltage signal is greater than a level of the reference voltage signal within a first period of time T1, and a level of the compensation voltage signal is equal to the level of the reference voltage signal within a second period of time T2, wherein T=T1+T2.

3. The display panel according to claim 1, wherein within the single period of driving time T of the signal line, the compensation voltage signal is constant.

4. The display panel according to claim 1, wherein the display panel further comprises a first detector, and the first detector detects a picture of the display panel; and
the compensation voltage generator is configured to adjust a level of the compensation voltage signal according to different pictures of the display panels.

5. The display panel according to claim 1, wherein the compensation voltage generator is configured to select a level of the compensation voltage according to different pictures of the display panels, and superimpose the level of the compensation voltage with a level of the reference voltage signal to form the compensation voltage signal.

6. The display panel according to claim 1, wherein the display panel further comprises a second detector, wherein the second detector detects a parasitic resistances and/or parasitic capacitances of the compensation line; and
the compensation voltage generator is configured to adjust the level of the compensation voltage signal according to the parasitic resistances and/or parasitic capacitances.

7. The display panel according to claim 1, wherein the display panel further comprises a third detector, wherein the third detector detects the reference voltage signal; and
the compensation voltage generator is configured to adjust the level of the compensation voltage signal according to the reference voltage signal.

8. The display panel according to claim 1, wherein the compensation voltage generator is configured to select a level of the compensation voltage according to a preset rule, and superimpose the level of the compensation voltage with a level of the reference voltage signal to form the compensation voltage signal.

9. A display, comprising a display panel, wherein the display panel comprises:
an array substrate comprising signal lines and at least one compensation line disposed on the array substrate, wherein the signal lines comprise a first disconnected line and a second disconnected line, and a first end of the second disconnected line is connected to a first end of the compensation line;
a reference voltage generator generates a reference voltage signal wherein a first end of the first disconnected line is connected to the reference voltage generator to transmit the reference voltage signal, and a disconnection was formed between the second end of the first disconnected line and the second end of the second disconnected line;
a compensation voltage generator generates a compensation voltage signal, wherein the second end of the compensation line is connected to the compensation voltage generator to transmit the compensation voltage signal to the second disconnected line;
wherein a level of the compensation voltage signal is greater than a level of the reference voltage signal.

10-16. (canceled)

17. A voltage compensation method of a display panel, the display panel comprises an array substrate, the array substrate comprises signal lines, and the signal lines comprises a first disconnected line and a second disconnected line, wherein a first end of the first disconnected line is connected to a reference voltage generator to transmit a reference voltage signal generated by the reference voltage generator, and an disconnection was formed between the second end of the first disconnected line and the second end of the second disconnected line;
wherein a first end of the second disconnected line is connected to a first end of the compensation line disposed on the array substrate, and the second end of the compensation line is connected to the compensation voltage generator to transmit the compensation voltage signal generated by the compensation voltage generator to the second signal line; and
the voltage compensation method comprises steps:
detecting a picture of the display panel;
adjusting a level of the compensation voltage signal according to different pictures of the display panels by the compensation voltage generator; and
within a single period of driving time T of the signal line, a level of the compensation voltage signal to be greater than the reference voltage signal within a first period of time T1, and a level of the compensation voltage signal is equal to the level of the reference voltage signal within a second period of time T2, wherein T=T1÷T2.

18. The voltage compensation method of the display panel according to claim 17, wherein within the single period of driving time T of the signal line, the compensation voltage signal is constant.

19. The display panel according to claim 1, wherein the compensation voltage generator is configured to select a level of the compensation voltage according to a preset rule and superimpose the level of the compensation voltage with the reference voltage signal to form the compensation voltage signal.

20. The display panel according to claim 1, wherein the reference voltage generator is electrically connected to the compensation voltage generator.

21. The voltage compensation method of the display panel according to claim 17, wherein the step of adjusting a level of the compensation voltage signal according to different pictures of the display panels by the compensation voltage generator comprises:
the compensation voltage generator directly adjusts the level of the compensation voltage signal according to different pictures of the display panels.

22. The voltage compensation method of the display panel according to claim 17, wherein the step of adjusting a level of the compensation voltage signal according to different pictures of the display panels by the compensation voltage generator comprises:
detecting different parameters of the display panel and adjusting the compensation voltage signal transmitted by the compensation voltage generator.

23. The voltage compensation method of the display panel according to claim 22, wherein the step of detecting different parameters of the display panel and adjusting the compensation voltage signal transmitted by the compensation voltage generator comprises:
detecting the parasitic resistances and/or parasitic capacitances of the compensation line, and the compensation voltage generator adjusts the level of the compensation voltage signal according to different parasitic resistances and/or parasitic capacitances.

24. The voltage compensation method of the display panel according to claim 22, wherein the step of detecting different parameters of the display panel and adjusting the compensation voltage signal transmitted by the compensation voltage generator comprises:
detecting the reference voltage signal, and the compensation voltage generator adjusts the level of the compensation voltage signal according to the reference voltage signal.
